(19) United States
(12) Patent Application Publication
(10) Pub. No.: US 2024/0192368 A1
(43) Pub. Date: Jun. 13, 2024

(54) Photonic Doppler Velocimetry System for Non-Specular Surfaces

(71) Applicants: DAVID MICHAEL GALLUS, Las Cruces, NM (US); Timothy David Gallus, Las Cruces, NM (US); Robert Michael Gallus, Las Cruces, NM (US)

(72) Inventors: DAVID MICHAEL GALLUS, Las Cruces, NM (US); Timothy David Gallus, Las Cruces, NM (US); Robert Michael Gallus, Las Cruces, NM (US)

(21) Appl. No.: 18/523,194

(22) Filed: Nov. 29, 2023

Related U.S. Application Data
(60) Provisional application No. 63/430,773, filed on Dec. 7, 2022.

(51) Int. Cl. G01S 17/58; G01S 7/481

(52) U.S. Cl. CPC G01S 17/58; G01S 7/4812; G01S 7/4818

(57) ABSTRACT

The present invention is concerned with the field of Photonic Doppler Velocimetry (PDV), specifically a new method of handling laser light in order to record the velocity history of a moving surface. Send and receive paths are separated to produce a high optical signal to noise ratio (S/N). For non-mirror like (non-specular) surfaces, designs which optimize the S/N for a send path compete with those that optimize the S/N for a receive path. A small solid angle for the send optics minimizes noise through laser stabilization. A large solid angle for receive optics maximizes the signal. When these separate optimized designs are combined in a probe, the S/N of overall system is greatly increased.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### REFERENCES AND OTHER PUBLICATIONS

Not Applicable

### BACKGROUND OF THE INVENTION

The present invention is concerned with the field of Photonic Doppler Velocimetry (PDV), specifically the method of collecting Doppler shifted light from a moving object in order to record a velocity history. PDV was originally developed by Ted Strand at Lawrence Livermore National Labs and has been used extensively by the shock physics community. Shock waves are predictable reflectors because of their smooth surfaces, but the application of PDV to a surface other than a shock wave poses a particular challenge. For example, a laser directed at an anodized aluminum surface produces a “mirror ball” effect in the returning light which must be efficiently captured for Doppler shift recording.

When light of a fixed wavelength is reflected by a moving object, the light undergoes a wavelength shift proportional to the velocity of that object. If the reflective object is moving toward the light source, the reflected light will undergo a wave train compression and the reflected light will have a higher frequency in proportion to the object velocity. The opposite will be true when the object moves away from the source light and a wave train expansion will result in a frequency downshift. With no object movement, reflected light will have the same frequency as incident light.

A PDV system is a Michelson style interferometer that is operated mainly within telecom fiber components rather than mostly in open air. One mirror leg of the interferometer is replaced with a test article. A velocity history of the test article is obtained by recording the Doppler shift of incident light as a function of time. Light directed toward an object is usually defined as the send signal and light collected after reflection is usually defined as the receive signal. The optics which direct light to and from a test article are known collectively as the probe. One function of a PDV probe is to efficiently collect Doppler shifted light and pass that light to a detector.

Present detectors and digitizers cannot read the Doppler shifted light frequency directly in the Terahertz range, so a different detection method has been devised. This method is analogous to an FM radio heterodyne system. Since a megahertz radio carrier frequency is beyond the limit of human hearing, audible sound is encoded in the compression and expansion of a carrier frequency. After receiving, this encoded broadcast is mixed with a local oscillator signal which is close to the carrier frequency. This is known as a heterodyne process. The difference between the carrier and the local oscillator creates a harmonic known as a beat frequency. The kilohertz beat frequency is one thousand times lower than the megahertz carrier frequency and is within the range of human hearing. In this way the output of the heterodyne reproduces the audible signal that was encoded into the carrier frequency previously at the broadcast point.

PDV systems operate in a similar fashion to the FM radio heterodyne. The Doppler shifted light collected by a probe is mixed with a laser which has a frequency close to the signal light frequency. The mixing of these lights creates streaming fringes which have a frequency that is one thousand times lower than that of the signal light. In PDV systems, those streaming fringes produce light intensity changes, and are also known as the beat frequency. Present high speed detectors convert the gigahertz beat frequency into an electrical signal that a high speed digitizer can record. Those detectors replace the screen at the output of a Michelson interferometer and the changes in the beat frequency are proportional to the velocity of a test article. Detectors and digitizers must possess sufficient resolution to produce the required range and quality of velocity history. Software to convert this voltage versus time record into a frequency versus time record uses a Fast Fourier Transform. Conversion from frequency to velocity requires a simple multiplication factor to produce a velocity history of a test article and integration of that velocity record can produce a position history of a test article.

Several definitions apply to the discussion of PDV optical components and operation. The primary quality measure of a PDV system is the ability to produce a stable signal-to-noise ratio. This ratio is derived by dividing the power of a desired signal by the power of the noise that interferes with that signal. There are optical and electrical signals, but the present invention focuses on the power of optical signals compared to optical noise.

The optical signal of a PDV system begins with the collection of reflected light. The strength of this Doppler shifted light that arrives at a detector is mainly dependent upon the collection efficiency of a probe. Once inserted into the fiber network, most of that collected power is delivered to create fringe contrast at a detector. Optical noise can arise from different components in the interferometry scheme. Also, optical noise can occur in amplitude and phase changes as well as wavelength changes. The combination of these optical noise sources through a PDV distribution system can culminate into very erratic behavior at a detector. Also, for multiplexed systems, optical noise generating interactions between wavelengths is possible.

The most effective way to improve the reliability of PDV recordings is to increase the Doppler shifted signal strength while reducing optical noise. Signal strength is mainly controlled by stable laser illumination power and probe design while optical noise reduction is usually accomplished by design changes throughout the entire system, including the probe.

Since PDV signal processing begins with the collection of light reflected from a test article, probe design is extremely important and must be tailored to reflection types. Reflectors are generally defined by the extent of their specularity. The meaning of the term specular is of, relating to, or having the qualities of a mirror. Therefore, the more an object reflects light as a mirror, the higher the reported specularity. Where the specularity is approximately one half, the surface is defined as glossy and the term for this type of reflection is glare. Also, where a surface specularity is zero, the surface is defined as a Lambert surface and reflections are described as diffuse. Anodized aluminum surfaces generally have a specularity of approximately one half and therefore are considered glossy when illuminated with white light. Prior art probes are not well suited to the collection of these types of reflections.

A discussion of light paths requires the definition of several variables. The cone over which an optical system collects light emanating from a reflection point is usually defined as a solid angle. The mathematical expression for this value is omega=A/(r squared), where A is the area of the probe face and r is the focal length. The units for this enveloping solid angle are reported in steradians. The angle which defines the cone of light used to illuminate an object can also be reported in steradians. The path that individual photons travel in an optical system are usually labeled as ray traces and the lines shown in the figures denote the paths which those individual beams of light travel.

Illumination by coherent and narrow band wavelength laser light reflects as a random pattern of speckles whose power distribution is generally Gaussian and centered around the send signal axis if the reflective surface is normal to the incident beam. These speckle patterns exhibit high contrast where small zones of very intense illumination are surrounded by a dark field. Also, while the average power distribution of the returned speckled area may be Gaussian, the base of the distribution is much wider than highly polished flat surfaces. Since the vector of reflected light varies with the geometry and surface condition of the object from which Doppler shifted light is collected, probes must be designed to accommodate these factors. Shock wave measurements are usually made with incident light directed perpendicular to the expected shock wave path. The single send and receive design of prior art is well suited to that original application of normal shock wave velocity measurements and prior art probes may be collimated or focusing, but their optic elements and transmission fibers are used for both the send and the receive signals. That design is simple and easy to manufacture which leads to low cost probes. The efficiency of these probes is high since the send and receive beams share the same optics and therefore the same paths. They are also inherently co-axial and co-focal. Reflections from a shock wave are analogous to ones from a beam splitter. In a beam splitter only a small portion of light is reflected and that reflected light is not greatly scattered. Applications outside the shock physics community require new PDV probe designs in order to attain stable high signal-to-noise ratios within a PDV system.

There are two variables which define the design space of PDV probes. The first is a solid angle difference between receive and send optics. This is expressed as delta omega and is equal to omega of the send path subtracted from omega of the receive path, all expressed in steradians. Since prior art uses the same optics for both receive and send signals, the difference between solid angles has been limited to zero.

The second variable used to define the design space of PDV probes is the ratio of send and receive solid angles. Since the ratio is derived by dividing the send solid angle by the receive solid angle, this ratio is unitless. Also, since prior art designs do not allow for decoupled send and receive signal paths, prior art has been limited to a send to receive solid angle ratio of one.

Although the uses of PDV have been expanded to include velocity measurements from glossy surfaces and even moving particle clouds, PDV probe designs have not evolved to accommodate these new applications. A few examples of these new applications are frangible joint characterizations, fragmentation studies of NASA Standard Initiators and NASA Standard Detonators, Equation of State studies of new materials such as Carbon Fiber Epoxy composites, particle clouds carried by gas flow, and titanium particles suspended in MON3 rocket engine oxidizer. While prior art probes can acquire some useful data from the above applications, they do not allow for production of the highest or most stable signal-to-noise ratios.

One difficulty posed by new applications is that the Gaussian distribution of a return signal moves off axis as the reflective surface is tilted off normal to the incident beam. During explosive events, reflection surfaces remaining normal to incident light is never guaranteed and small collection optics allow for dramatic return signal losses as the reflective object face tilts away from perpendicular. Therefore small collection optics do not allow for high return signal strength and continuous tracking, whereas large collection optics could provide a longer tilt angle tracking window. Additionally, signal strength could be improved by increasing the collection path solid angle. This means increasing the collection optic area, reducing the focal distance, or both. However, since prior art uses the same optics for both paths, the send optics solid angle will also increase. Enlarged send optics, reduced focal distance, or both will allow for more light to reflect back into the laser. Since lasers are destabilized when a small percent of the light they emit is reflected back into the laser cavity, back reflections must be minimized to allow for frequency, mode, and amplitude stability. As a destabilized laser signal propagates through a PDV distribution system, the instabilities will increase in proportion to the number of components they traverse on the way to a detector. Therefore, the smallest number of distribution components generally allows for lowered optical noise. A destabilized signal can drop completely to zero at critical times in the velocity history. In many applications this data loss is not acceptable.

In prior art probes, send and receive design goals compete for the production of highly stable signal to noise ratios. Ideally, to reduce noise, the send optics area should be reduced, the focal distance increased, or both in order to reduce the amount of light reflected back into the laser. While that design change will reduce noise, it will also reduce the signal. It becomes obvious to anyone skilled in the art of optics that prior art PDV probe limitations force a compromise between the goals of increased signal strength, noise reduction, and a signal-to-noise ratio which cannot be further stabilized or increased while the send and receive signals travel a common path.

Devices such as optical circulators are available to limit crosstalk in telecommunication equipment and these devices depend on tight polarization control to isolate light paths at high efficiency. Telecom optical circulators are used in prior art distribution systems to limit back reflections into signal lasers and to direct the maximum reflected signal to a detector. While these devices operate on the principal of circular polarization and this polarization is well controlled within telecom fiber systems, open air reflections on the probe leg of PDV interferometers for applications other than shock waves usually interrupt this polarization. That disruption makes circulators less effective at controlling the direction of signal paths and the signal-to-noise ratio is reduced in two ways. The lack of signal traffic control not only decreases the signal strength to the detector, but also creates system optical noise through laser destabilization, which propagates through the distribution system. Also, if signal laser frequency drift occurs, an optical circulator in a prior art configuration will introduce a great deal of amplitude instability as well. While the use of a circulator creates an inefficient operation when PDV is applied to applications other than shock waves, they are absolutely necessary for the operation of a system with prior art probes. Therefore, probe redesign that can eliminate the need for stand alone optical circulators is essential to attain the goal of stable high signal-to-noise ratios.

### SUMMARY OF THE INVENTION

In contrast to prior art, the present invention teaches a new approach to the handling of send and receive signals. The reduction to practice in the present invention teaches design guidelines and methods which allow separate send and receive path PDV probes to become a reality. The present invention also teaches materials and methods to be used in probe designs which accommodate PDV applications where light is scattered as it reflects from a moving object. Improvements in probe designs can lead to stable and increased signal-to-noise ratios. With these techniques and guidelines, a PDV system can deliver high signal-to-noise ratios as well as providing for distribution system simplification, a wider range of acceptable lasers, and reduced overall costs.

The teachings of the present invention show that PDV probe designers are free to consider the design needs of a send apparatus separately from the design needs of a receive apparatus without compromise of either. Consequently, the solid angles of these apparati no longer need to be identical and therefore the solid angle difference between these paths will no longer be zero. Any person skilled in the art will understand that this difference should result in a positive number up to some economical limit and the higher differences allow for maximized signal-to-noise ratios.

There are two probe design changes which can increase signal strength. The first change is an increase in the area of the collection optics and the second is a focal length reduction. Since a probe should be placed at a distance r from a test article, the focal length generally dictates that distance. The receive solid angle is increased as the area A is increased and also increased as the distance r is decreased. These combined changes will cause the signal-to-noise ratio to increase as well as the difference between receive and send solid angles.

The designer is now free to develop send optics designs independent of the receive optics requirements. Also, the locations of send and receive optics are now not required to be identical. While signal strength would be reduced if the collection optics were miniaturized and set at large distance from the test article, better signal laser stability could be realized if the send optics were given that treatment. This is made possible by the spatial coherence of laser beams which allows them to stay narrow over great distances. That property allows for a probe with a small area (A) of the send optics and a large distance (r) from the test article while still delivering high power to the small area of a test article to be interrogated. The advantage of a small send area is that less reflected light is sent back into the system toward the signal laser, which would destabilize it. The greater distance between the test article and the send optics also reduces the amount of back reflected light. If these back reflections are kept below a minimum value which is specific to each laser source, the laser output will remain stable. These trends in both A and r decrease the solid angle of the send optics. Those changes cause an increase in signal-to-noise ratio by reducing the noise created by laser destabilization. Solid angle reduction of the send optics increases the difference between the receive and send solid angles and moves designs closer to the goal of maximizing that difference above zero up to manufacturing and economic limits. Where light beams are collimated, the solid angle is zero. Consequently, in cases where the send signal is collimated, the difference between receive and send solid angles is equal to the receive solid angle since the solid angle of a collimated beam is zero.

While the present invention deviates from practices in prior art, there are practical limits to this excursion. The present invention anticipates designs which exhibit receive and send solid angle differences greater than zero steradians, but no greater than 300 steradians. This design space is located adjacent to prior art, but the range does not cross the value for prior art. The present invention also anticipates send and receive solid angle ratios less than one but greater than negative one. This design space is also located adjacent to prior art, but the range does not cross the value for prior art. These numbers automatically dictate the use of at least two transmission fibers per probe.

Since lasers can be seeded externally as well as internally, there is a finite level of back reflection that they can tolerate that does not lead to unacceptable destabilization and thus noise in a PDV system. This level is specific to each laser source. If back reflections can be held below this level by a send path design, optical circulators or other back reflection prevention schemes are not necessary. Essentially, careful probe geometry designs can replicate the function of an optical circulator. In an optical circulator polarizers, waveplates, and birefringent elements are used to switch signals to different physical locations based on their direction of travel. The output of the circulator is connected to this new physical location. The present invention employs the same switching by making use of the effect where light generally scatters into an annulus around an illumination point when the reflective surface is normal to the incident light. This is also the case when this pattern shifts off axis as surfaces tilt off normal. In these ways, the reflective surfaces themselves switch signals to a new physical location simultaneously with the change in beam direction. While non-specular reflections scatter light, large collection optics can catch that pattern. Those large optics can collect most of the annular reflections, within an economic radius, and insert them into a separate fiber to be delivered to a detector.

In some cases, a stable system that operates without an optical circulator can be made unstable with a different reflector. For example, covering an anodized aluminum test article with prismatic retro-reflective tape can cause the amplitude of a previously stable system to oscillate. In that case an increase in the solid angle differences and the solid angle ratio would have to be accomplished through a probe redesign that would re-stabilize laser operation.

A probe design which allows for the elimination of circulators can lead to the use of very simple low cost distribution systems. While the present invention describes probes that are more difficult to manufacture and therefore more expensive than common path collimated or focusing probes, this investment in tailored probes can result in a decrease of the overall PDV system cost as well as increased performance. Those simplified systems can allow for higher performance by increased signal-to-noise ratios and broader signal wavelength choices.

The ability to operate a PDV system at shorter wavelengths allows for increased spatial resolution over the typical 1550 nm telecommunication wavelengths. The wavelength of diode pumped fiber telecom lasers are controlled by cavity length through active tight controls on either power, current, or temperature. While 1550 nm systems offer the lowest signal attenuation possible for long haul telecom signals, most PDV systems span relatively short distances where visible wavelength fiber attenuations may be acceptable. Shorter wavelength signal lasers may allow for narrower line-widths as well as better wavelength stability as compared to telecommunication equipment. Narrow line-widths are necessary to differentiate between multiple particle velocities in a moving cloud.

Any of the beam delivery and reflection recovery schemes described above can be accomplished with fibers, lenses, and mirrors. Care must be taken to ensure that the fibers and lenses are deigned to transmit the wavelength of the signal laser without unacceptable attenuation. Mirrors are usually more expensive than lenses for the same solid angle, but they are achromatic over a wide range of wavelengths and therefore can be used with a wide variety of laser sources. Also, since the distribution of reflected light intensity is still generally Gaussian, there are limits to the size and focal length of collection optics past which designs become un-economical. Optical component mounting materials should be selected for maximum probe efficiency at use temperatures. Finally, to avoid low probe efficiency, the send and receive optics should be designed so that the beams are as co-axial and co-focal as possible at the test article surface position of maximum interest. While co-focal and co-axial alignment of the separate send and receive beam paths provide the highest signal, probes will still function with misalignments. Up to an offset of four inches between focal points is anticipated by the present invention. Similarly, up to eighty eight degrees between the axis of send and receive solid angles is anticipated by the present invention.

### BRIEF DESCRIPTION OF THE SEVERAL VIEWS OF THE DRAWINGS

The various embodiments of the present invention, as well as representations of prior art can be understood with reference to the following drawings. The components are not necessarily to scale. Also, in the drawings, like reference numerals designate corresponding parts throughout the several views:

FIG. 1 is a partial cross-sectional view of an example prior art probe design in operation;

FIG. 2 is a partial cross-sectioned view of one embodiment of the present invention where the emitted light is focused against a surface by a tapered fiber optic, and reflected light is collected by a lens;

FIG. 3 is a partial cross-sectioned view of one embodiment of the present invention where the emitted light is sent to a surface as a collimated beam, and reflected light is collected by a 90 degree off axis mirror;

FIG. 4 is a partial cross-sectioned view of another embodiment of the present invention where the emitted light is sent out to a particle cloud as a diverging cone, and reflected light is collected by a 90 degree off axis mirror;

FIG. 5 a number line chart depicting the receive to send solid angle differences for various designs;

FIG. 6 a number line chart depicting the ratio of send to receive solid angles for the present invention as well as prior art;

FIG. 7 illustrates a typical prior art configuration of a PDV distribution apparatus connected to a prior art probe;

FIG. 8 illustrates the preferred use of a separate send and receive PDV probe and the PDV distribution system designed with the teachings of the present invention

### DETAILED DESCRIPTION OF THE INVENTION

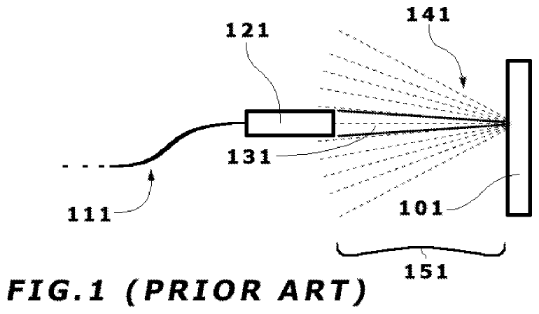

FIG. 1 illustrates a typical prior art probe design in operation. The test article 101 is shown reflecting incident light backwards to the probe 121 face. Only a small portion of the widely scattered reflections 141 from the test article 101 are intercepted by the probe 121 face. The only open space beam path 151 occurs between the probe 121 face and the test article 101. In this case the lost reflected return signal 141 is not necessarily unacceptable. Both send and receive signals travel along the single fiber 111. The solid angle of the send path from the probe 121 face and the test article 101 is identical to the solid angle of the receive path 131 since the optical elements are identical for both paths. In this case, the difference in-between the receive and send solid angles is zero steradians and is derived by subtracting the omega of the send optical elements 131 from the omega of receive optical elements 131. Furthermore, since the omega of the send optical elements 131 is the same as the omega of receive optical elements 131 the ratio of send and receive solid angles for this configuration would be one. When the omega of send optical elements is not the same as the omega of receive optical elements, at least two transmission fibers and separate send and receive paths are dictated.

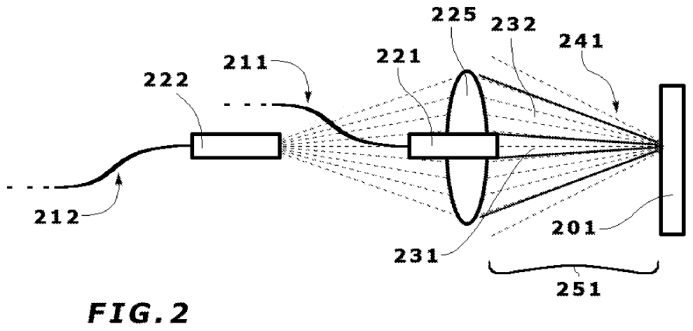

FIG. 2 shows one anticipated embodiment of the present invention. This drawing shows that all optical elements are either lenses or fibers. The one open space beam path 251 occurs between the send optics 221 face and the test article 201, while separate open beam path occurs between the test article 201 and the receive optical elements face 225. The send path solid angle 231 is less than the receive path solid angle 232. Some of the scattered light 241 is not collected by the receive signal optics 225, but enough is collected within the receive path solid angle 232 to provide for a strong return signal. The lost reflected return signal 241 is acceptable in this case. If the diameter of the send optics is assumed to be one fourth of an inch, the difference between receive and send solid angles shown is approximately 0.54 steradians. The send to receive sold angle ratio shown is approximately 0.046 which is unitless. The ray traces of the send and receive paths shown are co-focal and co-axial and perpendicular to the test article surface. This arrangement will deliver the strongest possible signal. This co-focal point should be located where the highest data accuracy within a movement record is required, since signal strength will be decreased on either side of this location from the probe faces. The first element on the receive path is the collection lens 225 which relays the Doppler shifted reflected light 232 into the fiber coupling optics 222. The send signal travels along the fiber 211 while the received signal travels along the separate fiber 212.

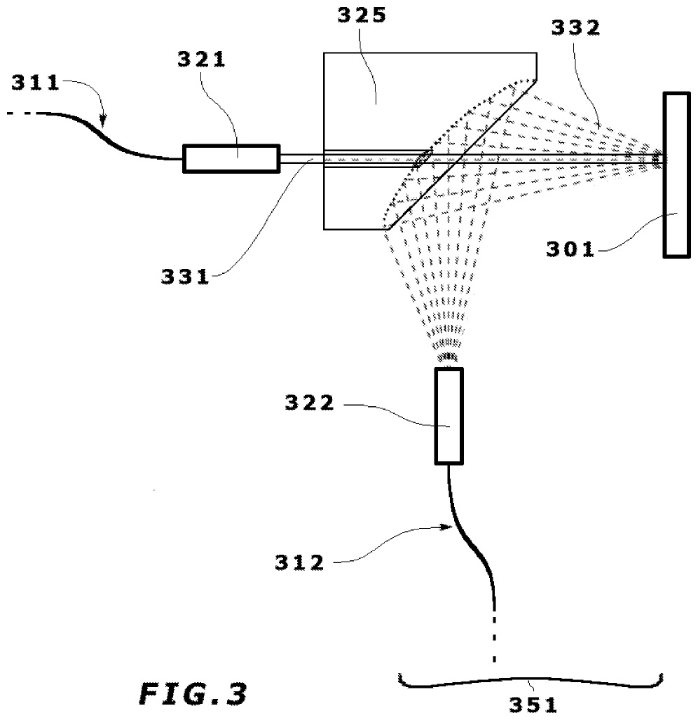

FIG. 3 shows another anticipated embodiment of the present invention. This drawing shows that some optical elements are the fibers 311 and 312, the fiber coupling optics 321 and 322, and the mirror 325. The send path is collimated and therefore the solid angle 331 is zero. All of the scattered light is collected by the receive signal collection mirror 325, across the open space beam path 351 and folded 90 degrees into the fiber coupling optic 322 to provide for a strong return signal. This 90 degree bend may be useful in some applications where space for multiple probes is not available laterally but is vertically. The difference between receive and send solid angles is equal to the solid angle 332 of the collection mirror 325 since the solid angle of the collimated send path 331 is zero. Since diameter of the effective collection area of the mirror 325 is 1.25 inches, the solid angle of the receive optics would be 0.54 steradians. The send to receive solid angle ratio is zero since the collimated send angle is zero divided by the receive path solid angle. The ray traces of the send and receive paths shown are co-focal and co-axial and perpendicular to the test article 301 surface. This arrangement in open air transmission space will deliver the strongest possible signal. The co-focal point should be located where the highest data accuracy within a movement record is required, since signal strength will be decreased on the far side of this location from the probe faces. The first element on the receive path is the collection mirror 325 which relays the Doppler shifted reflected light 332 into the additional fiber coupling optic 322 and out through the fiber 312 to the fringe creating devices. The send signal travels along the fiber 311 while the received signal travels along the separate fiber 312.

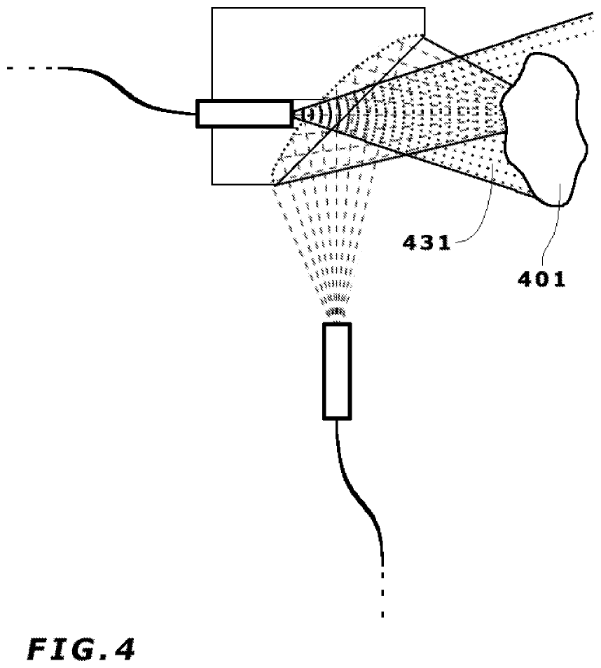

Diverging send signals are anticipated by this invention because that configuration may be necessary to measure the velocity distribution of a particle cloud. FIG. 4 shows a scheme for acquiring the Doppler shift history of the cloud of particles 401. While the diverging beam 431 or expanded collimated beam may reduce probe efficiency, the ability to track multiple particles is increased. A low signal to noise ratio could be increased with a higher power send signal without necessarily increasing noise from higher power laser back reflections. In this case the send beam solid angle would be −0.038 steradians, and the receive optics solid angle would be 0.56 steradians. The difference between receive and send solid angles is 0.6 steradians and the send to receive solid angle ratio would be −0.068.

While the probe designs of FIG. 2, FIG. 3, and FIG. 4 are not as compact as prior art designs, they still represent probes of practical scale. The present invention can be packaged into a probe no larger than one cubic foot. A breadboard assembly of the present invention may be as large as a test article itself and therefore impractical for multiple readings.

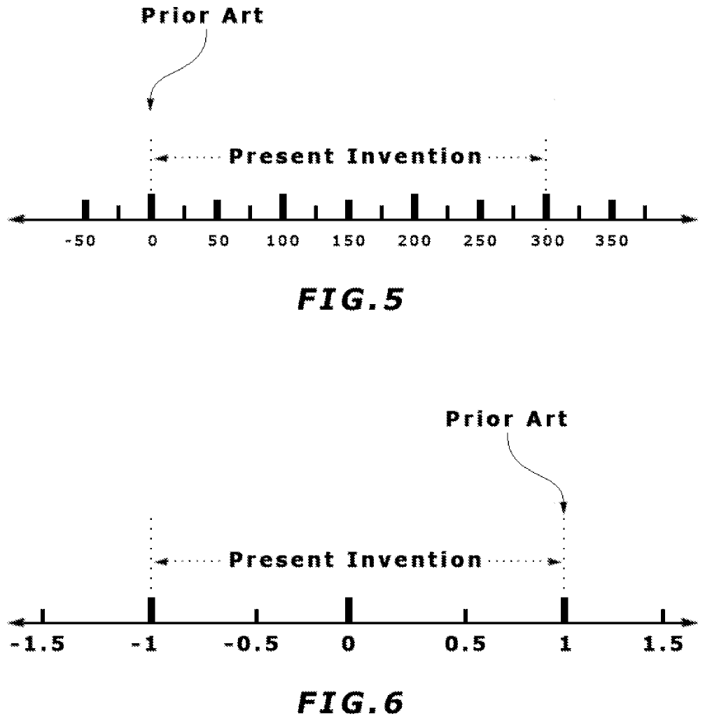

FIGS. 5 and 6 illustrate the design variables recommended by the present invention. FIG. 5 shows a number line of receive to send solid angle differences for various designs. That difference is shown at zero for prior art. At that point, a probe will not function without an optical circulator. If the send optics solid angle is reduced, back reflections into the signal laser are decreased and therefore optical noise is also decreased. If the reduction of the send optics solid angle is continued, at some point specific to each laser, the laser will become stable without an optical circulator. The other method of increasing solid angle difference is to increase the collection optics solid angle. This increases signal strength. Both of these changes improve the signal-to-noise ratio, however toward the maximum value of 300, other design considerations compete with the desire for a larger signal-to-noise ratio. The Gaussian power distribution of light collected off axis decelerates at larger solid angles, and since large lenses and mirrors are expensive, a probe over a certain size will provide a diminishing performance return. Space requirements may also become a problem as collection optics are larger and send optics are further away. The optimal solid angle difference is usually some number centered around 2, but is always between 0 and 300. The optimal solid angle difference is dependent on the test article surface absorption and specularity as well as signal laser stability requirements. This design space is located adjacent to prior art, but the range does not cross the value for prior art.

FIG. 6 shows a number line of the design space for the ratio of send to receive solid angles for the present invention as well as prior art. The region of the number line between zero and prior art at one applies to designs shown in FIG. 2 where both send and receive signal paths are focused at the test article. When the send beam is collimated, the zero point on the number line applies. The diverging send beam of FIG. 4 has a negative solid angle and therefore the region of the number line that applies to that design is between zero and negative one. This design space is located adjacent to prior art, but the range does not cross the value for prior art.

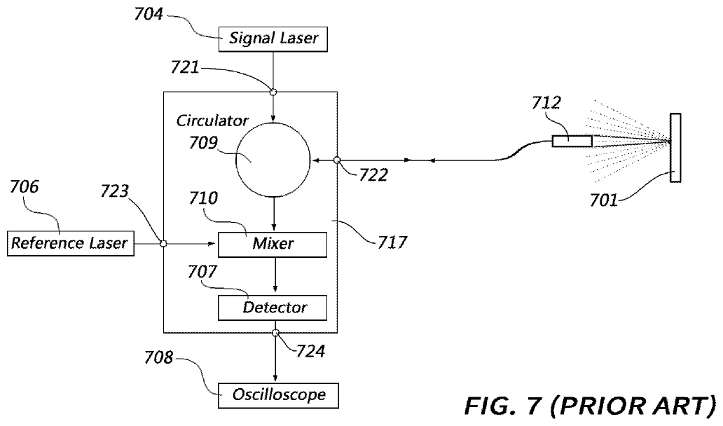

FIG. 7 shows a typical prior art configuration of a PDV distribution apparatus connected to a prior art probe. This distribution apparatus 717 is a collection of components which has three optical connections 721, 722 and 723 and the single electrical connector 724, and may be supplied by manufacturers such as Third Millennium Engineering (TME). This collection of optical and electrical components 717 is generally known as a receiver. The receiver 717 routes laser light from the signal laser 704 through the connector 721 to the optical circulator 709. The optical circulator 709 sends light through the connection 722 to the prior art probe 712. The prior art probe 712 focuses the signal laser light onto the test article 701, as well as receives the reflected light through the same optics. A portion of the reflected light is routed back along the same fiber through the connection 722, and back into the optical circulator 709. The optical circulator 709 directs much of the reflected light to the mixer 710, but also allows some of the reflected light back through the connection 721 and into the signal laser 704. The reflected light and the light from the reference laser 706 is combined within the mixer 710 and routed to the detector 707. Fringes, which are light intensity changes, are produced at the detector 707 which converts these light intensity changes into electrical signals that are then recorded by the high speed oscilloscope 708.

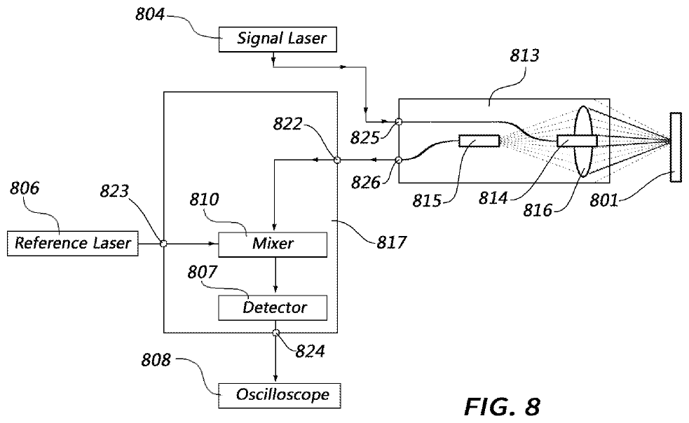

FIG. 8 shows the preferred use of the probe 813 and the PDV distribution apparatus 817 designed with the teachings of the present invention. This distribution apparatus 817 is a collection of components which has only two optical connections 822 and 823 and the single electrical connector 824. This collection of optical and electrical components 817 is generally known as a receiver. Laser light from the signal laser 804 is routed directly to the send optics 814 through the connector 825 of the independent probe 813 and focused onto the test article 801 surface. The send optical elements 814 are designed to keep back-reflected light below the destabilization power level of the signal laser 804 by means of an intentionally small solid angle. The return optics 816 collect a large amount of reflected Doppler shifted light with an intentionally large solid angle and directs it to the fiber coupling optics 815. The reflected Doppler shifted light is then sent out of the probe 813 through the connection 826, and into the optical connection 822 of the receiver 817. A fiber then routes the Doppler shifted light directly to the mixer 810 for a stable high signal-to-noise ratio. The reflected light and the light from the reference laser 806 is combined within the mixer 810 and routed to the detector 807. Fringes, which are light intensity changes, are produced at the detector 807 which converts these light intensity changes into electrical signals that are then recorded by the high speed oscilloscope 808.

Although exemplary embodiments of the invention have been shown and described, many other changes, modifications and substitutions, in addition to those set forth in the above paragraphs may be made by one having ordinary skill in the art without necessarily departing from the spirit and scope of this invention. Any combination of fibers, lenses, or mirrors could be used to establish ray traces which fit the ranges of solid angle differences and solid angle ratios described above. Any combinations of fibers with flat polished ends or tapered as those supplied by Oz optics ltd, lenses, or mirrors may be employed to conduct light out from a fiber or into a fiber efficiently. Anti-reflective coatings on lenses may be used as well. All designs within the design spaces defined above will require at least two fibers per probe.

What is claimed:

1. A photonic Doppler velocimetry probe assembly comprising:
A probe assembly having at least one means of directing light towards a surface or surfaces, and at least one means of receiving reflected light from a surface or surfaces;
with at least one optical connection for the sent light, and at least one optical connection for the received light;
wherein the difference between the solid angle of the received light path and the solid angle of the sent light path is greater than 0 steradians but not greater than 300 steradians;
wherein the physical envelope of the probe assembly is no larger than 1 cubic foot.

2. The photonic Doppler velocimetry probe assembly of claim 1, wherein the ratio of the sent light path solid angle to the received light path solid angle is between 1 and −1.

3. The photonic Doppler velocimetry probe assembly of claim 1, wherein the directing of light towards a surface or surfaces is accomplished by the use of at least one lens.

4. The photonic Doppler velocimetry probe assembly of claim 1, wherein the receiving of reflected light from a surface or surfaces is accomplished by the use of at least one lens.

5. The photonic Doppler velocimetry probe assembly of claim 1, wherein the directing of light towards a surface or surfaces is accomplished by the use of at least one mirror.

6. The photonic Doppler velocimetry probe assembly of claim 1, wherein the receiving of reflected light from a surface or surfaces is accomplished by the use of at least one mirror.

7. The photonic Doppler velocimetry probe assembly of claim 1, wherein the directing of light towards a surface or surfaces is accomplished by the use of at least one fiber.

8. The photonic Doppler velocimetry probe assembly of claim 1, wherein the receiving of reflected light from a surface or surfaces is accomplished by the use of at least one fiber.

9. The photonic Doppler velocimetry probe assembly of claim 1, wherein the angle deviation from co-axial between the sent light path and the received light path is no greater than 88 degrees;

10. The photonic Doppler velocimetry probe assembly of claim 1, wherein the distance between the focal point of the sent light path and the focal point of the received light path is no greater than 4 inches;

11. A photonic Doppler velocimetry probe assembly comprising:
A probe assembly having at least one means of directing light towards a surface or surfaces, and at least one means of receiving reflected light from a surface or surfaces;
with at least one optical connection for the sent light, and at least one optical connection for the received light;
wherein the ratio of the sent light path solid angle to the received light path solid angle is between 1 and −1;
wherein the physical envelope of the probe assembly is no larger than 1 cubic foot.

12. The photonic Doppler velocimetry probe assembly of claim 11, wherein the difference between the solid angle of the received light path and the solid angle of the sent light path is greater than 0 steradians but not greater than 300 steradians;

13. The photonic Doppler velocimetry probe assembly of claim 11, wherein the directing of light towards a surface or surfaces is accomplished by the use of at least one lens.

14. The photonic Doppler velocimetry probe assembly of claim 11, wherein the receiving of reflected light from a surface or surfaces is accomplished by the use of at least one lens.

15. The photonic Doppler velocimetry probe assembly of claim 11, wherein the directing of light towards a surface or surfaces is accomplished by the use of at least one mirror.

16. The photonic Doppler velocimetry probe assembly of claim 11, wherein the receiving of reflected light from a surface or surfaces is accomplished by the use of at least one mirror.

17. The photonic Doppler velocimetry probe assembly of claim 11, wherein the directing of light towards a surface or surfaces is accomplished by the use of at least one fiber.

18. The photonic Doppler velocimetry probe assembly of claim 11, wherein the receiving of reflected light from a surface or surfaces is accomplished by the use of at least one fiber.

19. The photonic Doppler velocimetry probe assembly of claim 11, wherein the angle deviation from co-axial between the sent light path and the received light path is no greater than 88 degrees;

20. The photonic Doppler velocimetry probe assembly of claim 11, wherein the distance between the focal point of the sent light path and the focal point of the received light path is no greater than 4 inches;

21. A method of utilizing separate send and receive signal paths within a photonic Doppler velocimetry system, the method comprising:
A probe assembly having at least one means of directing light towards a surface or surfaces, and at least one means of receiving reflected light from a surface or surfaces;
with at least one optical connection for the sent light, and at least one optical connection for the received light;
wherein the difference between the solid angle of the received light path and the solid angle of the sent light path is greater than 0 steradians but not greater than 300 steradians;
wherein the physical envelope of the probe assembly is no larger than 1 cubic foot. also comprising a light source that is conveyed to the sent light connection of a photonic Doppler velocimetry probe, and
further comprising a means of conveying and mixing the received light from the received light connection of the photonic Doppler velocimetry probe with a reference light source to produce interference fringes that can be converted by an optical detector.

22. A method of utilizing separate send and receive signal paths within a photonic Doppler velocimetry system, the method comprising:
A probe assembly having at least one means of directing light towards a surface or surfaces, and at least one means of receiving reflected light from a surface or surfaces;
with at least one optical connection for the sent light, and at least one optical connection for the received light;
wherein the ratio of the sent light path solid angle to the received light path solid angle is between 1 and −1;
wherein the physical envelope of the probe assembly is no larger than 1 cubic foot. also comprising a light source that is conveyed to the sent light connection of a photonic Doppler velocimetry probe, and
further comprising a means of conveying and mixing the received light from the received light connection of the photonic Doppler velocimetry probe with a reference light source to produce interference fringes that can be converted by an optical detector.
